(19) United States
(12) Patent Application Publication
(10) Pub. No.: US 2006/0260037 A1
(43) Pub. Date: Nov. 23, 2006

(54) Barrel-type steam and hot-air bath appliance

(76) Inventor: Hung-Lieh Chen, Taipei (TW)

Correspondence Address: BRUCE H. TROXELL, SUITE 1404, 5205 LEESBURG PIKE, FALLS CHURCH, VA, 22041, US

(21) Appl. No.: 11/364,326

(22) Filed: Mar. 1, 2006

(30) Foreign Application Priority Data
Apr. 22, 2005 (TW) 094206451

(51) Int. Cl. A61H 33/06

(52) U.S. Cl. 4/524

(57) ABSTRACT

A barrel-type steam and hot-air bath appliance includes a pottery barrel serving as a steam or hot-air room, a heating device, and a delivery pipe line. The pottery barrel has a volume sufficient for a user to sit therein, and has a layer of powdered minerals applied on an inner wall and bottom surface to release anions when a predetermined temperature is reached. The heating device may heat water or air to produce steam or hot air, which is delivered into the pottery barrel via the delivery pipe line. Therefore, a user may enjoy a steam or hot-air bath with a large quantity of health-beneficial anions in the pottery barrel.

### FIELD OF THE INVENTION

The present invention relates to a barrel-type steam and hot-air bath appliance, and more particular to a steam and hot-air bath appliance using a pottery barrel as a steam or hot-air room. The pottery barrel can be easily washed clean to remove any residual toxicant and is therefore safer for use in terms of sanitation and health care.

### BACKGROUND OF THE INVENTION

Most people in the modern society lack sport and exercise to result in lowered metabolism and accumulation of many health-impairing toxicants in the body, which in turn results in various kinds of diseases in connection with metabolism, such as gout, kidney-related diseases, liver-related diseases, etc. Steam bath and hot-air bath have been widely adopted by many people as one way to quickly discharge accumulated toxicants from the body through sweating.

Through high-temperature steam bath, pores on skin are thoroughly cleaned by steam, and some toxicants stayed in the body could be discharged via pores through sweating. In a hot-air bath, infrared produced under a high temperature is utilized to provide an effect similar to moxibustion that energizes cells and tissues deep in the body to benefit health.

Currently, most family-purpose steam and hot-air bath rooms are made of wood, which is a fibrous material and has a plurality of pores on its surface. Dirt and other types of residues, including toxic residues, tend to stay in these pores and are hard to wash off. The toxicants from other users and remained on the surface of the wooden steam and hot-air bath room would very possibly enter into the next user's body to cause disease or discomfort. This would largely endanger and reduce the generally known health-beneficial effect of steam and hot-air bath.

It is therefore tried by the inventor to develop a steam and hot-air bath appliance using a pottery barrel as a steam and hot-air room to eliminate drawbacks existed in the conventional wooden steam and hot-air bath appliance.

### SUMMARY OF THE INVENTION

A primary object of the present invention is to provide a barrel-type steam and hot-air bath appliance, in which a pottery barrel is used as a steam or hot-air room, so that the pottery barrel can be easily washed clean to remove any residual toxicant discharged from a user.

Another object of the present invention is to provide a barrel-type steam and hot-air bath appliance, in which a layer of powdered minerals is applied on an inner wall and bottom surface of a pottery barrel served as a steam or hot-air room, so that health-beneficial anions are released when the pottery barrel is heated to a predetermined temperature.

To achieve the above and other objects, the barrel-type steam and hot-air bath appliance according to the present invention includes a pottery barrel, a top cover for closing a top opening of the barrel, a heating device, and a delivery pipe line. The pottery barrel serves as a steam or hot-air room having a volume sufficient for a user to sit therein. The heating device may heat water or air to produce steam or hot air, which is delivered into the pottery barrel via the delivery pipe line.

The pottery barrel is internally provided with a chair and a footrest for the user to comfortably and stably sit in the pottery barrel. A steam or hot-air inlet, a drain hole, and a water inlet are provided at predetermined positions on the pottery barrel.

The pottery barrel has a layer of powdered minerals applied on an inner wall and bottom surface to release anions at a temperature higher than 45° C. Therefore, a user may safely enjoy a steam or hot-air bath with a large quantity of health-beneficial anions in the pottery barrel.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a barrel-type steam and hot-air bath appliance according to an embodiment of the present invention; and

FIG. 2 is a sectioned side view of FIG. 1.

### DETAILED DESCRIPTION OF THE PREFERRED EMBODIMENTS

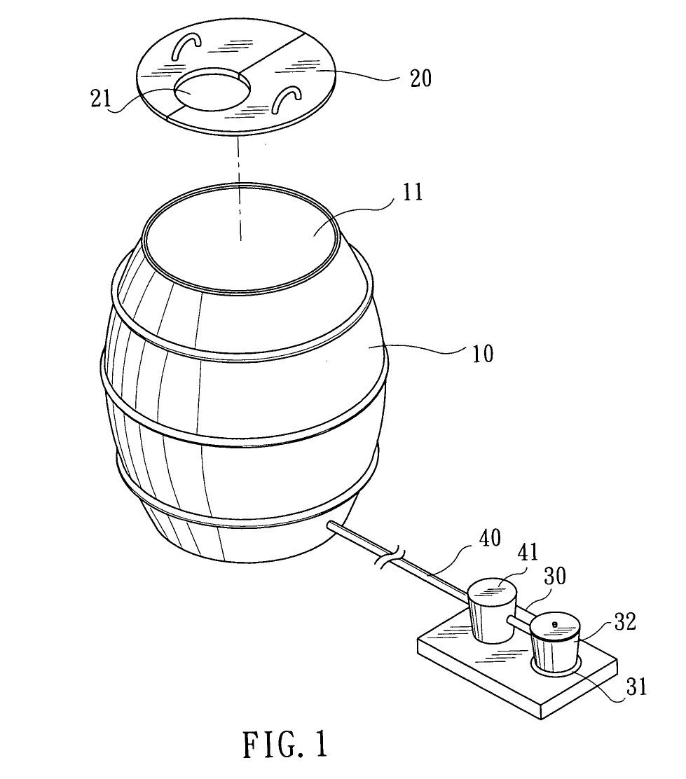

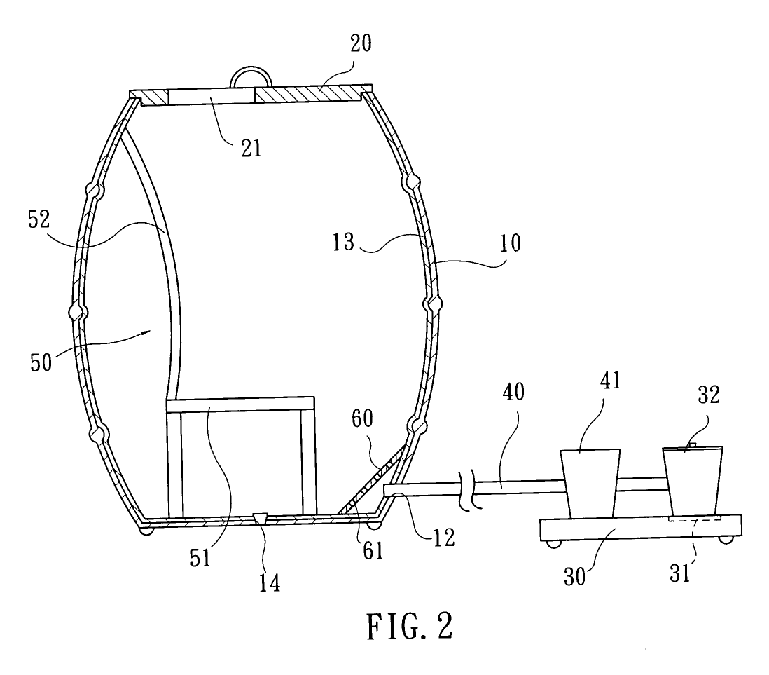

Please refer to FIGS. 1 and 2 that are perspective and sectioned side views, respectively, of a barrel-type steam and hot-air bath appliance according to an embodiment of the present invention. As shown, the barrel-type steam and hot-air bath appliance includes a pottery barrel 10, a top cover 20 for closing a top opening 11 of the barrel 10, a heating unit 30, and a delivery pipe line 40.

The pottery barrel 10 has a volume sufficient for a user to enter and sit therein. The top cover 20 includes two halves that can be put together along a joint line to form a complete piece for closing the top opening 11 of the barrel 10. Each of the two halves of the top cover 20 is provided at the joint line with a cut, such that a substantially round hole 21 is formed by the cuts on the two halves when they are put together to complete the top cover 20. The round hole 21 is so sized and located that it just loosely encloses a user's neck portion when the user is sitting in the barrel 10.

The heating unit 30 includes a heater 31 and a container 32 for storing an amount of water or air. The heater 31 is adapted to heat the water or air in the container 32, so as to produce steam or hot air.

The delivery pipe line 40 is extended between the pottery barrel 10 and the container 32 of the heating device 30 to communicate the barrel 10 with the container 32, so that steam or hot air produced in the container 32 is delivered into the barrel 10 via the delivery pipe line 40.

As can be seen from FIG. 2, the pottery barrel 10 is internally provided with a chair 50 and a footrest 60. The chair 50 includes a seat 51 and a backrest 52 for a user to stably and comfortably sit thereon. The footrest 60 is so positioned that the user may comfortably rest two feet thereon when sitting on the chair 50. The footrest 60 is provided with a plurality of small holes 61, via which steam or hot air delivered into the pottery barrel 10 reaches at the user's sole to stimulate points at the sole and generate an effect similar to that of moxibustion in Chinese medicine. The pottery barrel 10 is provided on a wall behind the footrest 60 with a steam or hot air inlet 12, so that steam or hot air entering into the barrel 10 would first reach at the user's feet rested on the footrest 60. Thereafter, the steam or hot air flows to two sides of the footrest 60 into the remaining space in the pottery barrel 10.

The pottery barrel 10 is provided on an inner wall surface and bottom surface with a layer of powdered minerals 13, which is adapted to release a large quantity of anions at a temperature higher than 45° C. It is good for the user's health when the number of released anions in the pottery barrel 10 is between 1000 and 2000. And, it is helpful in increasing the user's resistance and immunity when the number of released anions in the pottery barrel 10 is between 5000 and 10000. Therefore, when the pottery barrel 10 is heated to a high temperature by the steam or the hot air delivered thereto, a large quantity of anions is generated from the powdered mineral layer 13 to provide in the pottery barrel 10 an environment capable of enhancing the user's health.

The heater 31 of the heating device 30 is adapted to heat the water or air in the container 32 to produce steam or hot air. The delivery pipe line 40 has an end communicating with the container 32 and another end connected to the steam or hot air inlet 12 on the barrel 10, so as to deliver produced steam or hot air into the pottery barrel 10 via the steam or hot air inlet 12. For the pottery barrel 10 to maintain at stable internal steam or air pressure, a steam or hot air storage tank 41 is provided on the delivery pipeline 40 to store the produced steam and hot air. When the storage tank 41 has an internal pressure larger than that of the pottery barrel 10, steam or hot air stored in the storage tank 41 is automatically delivered to the pottery barrel 10 from the storage tank 41.

The pottery barrel 10 may also be used as a bath tub. A drain hole 14 is provided at the bottom of the barrel 10 for draining off used bath water and cleaning water.

The pottery barrel 10 used in the steam and hot air bath appliance of the present invention is easy to wash clean and is therefore safer and more reliable for use in terms of sanitation. Since the powdered mineral layer 13 on the inner wall of the pottery barrel 10 is able to release a large quantity of human-beneficial anions when the pottery barrel 10 for steam and hot-air bath is in use, the present invention provides enhanced health-improving effect.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A barrel-type steam and hot-air bath appliance, comprising a pottery barrel serving as a steam or hot-air room, a heating device, and a delivery pipe line; said pottery barrel having a volume sufficient for a user to enter and sit therein; said heating device heating water in a container to produce steam; and said delivery pipe line communicating said pottery barrel with said container to deliver the produced steam from said container into said pottery barrel.

2. The barrel-type steam and hot-air bath appliance as claimed in claim 1, wherein said container without water can be heated by said heating device to produce hot air in said container.

3. The barrel-type steam and hot-air bath appliance as claimed in claim 1, wherein said pottery barrel is provided on an inner wall surface and bottom surface with a layer of powdered minerals.

4. The barrel-type steam and hot-air bath appliance as claimed in claim 1, further comprising a top cover for closing a top opening of said pottery barrel.

5. The barrel-type steam and hot-air bath appliance as claimed in claim 4, wherein said top cover includes two halves that can be put together along a joint line to close said top opening of said pottery barrel, and each of said two halves of said top cover being provided at said joint line with a cut, such that a substantially round hole for loosely enclosing the user's neck portion is formed from said cuts on said two halves when said two halves are put together to complete said top cover.

6. The barrel-type steam and hot-air bath appliance as claimed in claim 1, wherein said pottery barrel is internally provided with a chair for a user to sit thereon.

7. The barrel-type steam and hot-air bath appliance as claimed in claim 1, wherein said pottery barrel is internally provided with a footrest for a user in said pottery barrel to rest two feet thereon.

8. The barrel-type steam and hot-air bath appliance as claimed in claim 7, wherein said footrest is provided with a plurality of through holes.

9. The barrel-type steam and hot-air bath appliance as claimed in claim 1, wherein said heating device includes a heater for heating said container.

10. The barrel-type steam and hot-air bath appliance as claimed in claim 1, wherein said delivery pipe line has a steam or air storage tank provided thereon for storing the steam produced by said heating device.
